(19) United States
(12) Patent Application Publication
(10) Pub. No.: US 2016/0292370 A1
(43) Pub. Date: Oct. 6, 2016

(54) TELEMEDICINE SYSTEM INCLUDING INSURANCE BILLING

(71) Applicant: MendGroup, Inc., Seattle, WA (US)

(72) Inventor: Adnan Saric, Seattle, WA (US)

(21) Appl. No.: 15/085,632

(22) Filed: Mar. 30, 2016

Related U.S. Application Data
(60) Provisional application No. 62/140,379, filed on Mar. 30, 2015.

(51) Int. Cl. G06F 19/00

(52) U.S. Cl. CPC G06F 19/328

(57) ABSTRACT

An insurance billing computing system determines whether a first health care provider accepts one or more insurance plans of a first insurance provider that insures a patient; receives one or more billing codes that respectively indicate one or more health care services performed by the first health care provider for the patient during a telemedicine session conducted via a first patient computing device and a health care provider computing system; generates at least one insurance claim based at least in part on the one or more billing codes that respectively indicate the one or more health care services performed by the first health care provider for the patient during the telemedicine session; and submits the at least one insurance claim to the first insurance provider via an insurance provider computing system.

### BACKGROUND

1. Technical Field

The present disclosure generally relates to telemedicine systems. More particularly, the present disclosure relates to billing medical services insurance in a telemedicine system.

2. Description of the Related Art

In a traditional health care scenario, a patient visits a health care provider's place of business and one or more health care services are performed by the health care provider. The health care provider and/or the patient may then submit an insurance claim to an insurance provider that insures the patient.

With the advancement of telecommunication and information technologies, telemedicine or teleheath systems now enable the patient and health care provider to interface remotely, thereby reducing costs associated with transportation, waiting periods, office space, and other items required for a face-to-face visit. In addition, telemedicine systems provide access to services that might not otherwise be available to the patient due to, for example, lack of qualified local providers or patient immobility.

### BRIEF SUMMARY

Electronic submission of the insurance claim can require use of an insurer-specific web-interface, which can be inefficient and challenging if performed by the patient or an inexperienced representative of the health care provider.

Likewise, insurance billing systems do not yet exist within the framework of telemedicine systems. In particular, not all telemedicine costs are equivalently reimbursable as compared to similar services performed face-to-face. Such may be further complicated by disparate treatment of telemedicine insurance claims based on the state in which the patient resides and disparate treatment of telemedicine insurance claims by different insurance providers.

Confusion engendered by such disparate treatment, if not addressed prior to conducting the telemedicine session, can result in significant accidental and un-reimbursable out-of-pocket costs to the patient.

Thus, the use of telemedicine systems to provide health care services has created new problems rooted in technology, particularly in the realm of automated or computer-assisted insurance billing. In particular, in current systems, a human user is required to engage with multiple different computer systems or entities in order to properly determine claim eligibility and perform claim submission. The use of telemedicine systems also presents new challenges relating to fraud detection and prevention which did not exist in traditional health care scenarios, due to the in-person or face-to-face nature of conventional health care visits.

Therefore, a telemedicine system that performs streamlined and user-friendly insurance billing while preventing or reducing the occurrence of fraud is desirable.

A computer-implemented method in a telemedicine system that includes at least a first patient computing device, a health care provider computing system, and an insurance billing computing system that includes at least one processor, may be summarized as including: receiving, by the insurance billing computing system, information that identifies a patient that operates the first patient computing device, information that identifies a current geographical location of the patient computing device, information that identifies at least a first health care provider that operates the health care provider computing system, and information that identifies at least a first insurance provider that insures the patient; determining, by the insurance billing computing system, whether the first health care provider accepts one or more insurance plans of the first insurance provider based at least in part on the received information that identifies a patient that operates the first patient computing device, the information that identifies a current geographical location of the patient computing device, the information that identifies at least a first health care provider that operates the health care provider computing system, or the information that identifies at least a first insurance provider that insures the patient; receiving, by the insurance billing computing system, one or more billing codes that respectively indicate one or more health care services performed by the first health care provider for the patient during a telemedicine session conducted via the first patient computing device and the health care provider computing system; generating, by the insurance billing computing system, at least one insurance claim based at least in part on the one or more billing codes that respectively indicate the one or more health care services performed by the first health care provider for the patient during the telemedicine session; and submitting, by the insurance billing computing system, the at least one insurance claim to the first insurance provider via an insurance provider computing system.

The computer-implemented method may further include: receiving, by the insurance billing computing system, information that verifies that the telemedicine session occurred between the patient and the first health care provider. The computer-implemented method may further include: determining, by the insurance billing computing system, whether the first health care provider accepts one or more insurance plans of the first insurance provider based at least in part on the received information that verifies that the telemedicine session occurred between the patient and the first health care provider. Receiving information that verifies that the telemedicine session occurred between the patient and the first health care provider may include receiving information which indicates an occurrence of a real-time communication between the patient computing device and the health care provider computing system. The computer-implemented method may further include: receiving, by the insurance billing computing system, information that identifies at least one of a start time, end time or duration of the telemedicine session; and determining, by the insurance billing computing system, whether the first health care provider accepts one or more insurance plans of the first insurance provider based at least in part on the received information that identifies at least one of a start time, end time or duration of the telemedicine session. Receiving information that identifies a current geographical location of the patient computing device may include receiving information relating to one or more of an Internet Protocol (IP) address, a media access control (MAC) address, an RFID identifier, a hardware embedded identifier, a software embedded identifier, Wi-Fi® location data, cell tower location data, a device fingerprint, or device GPS data. The computer-implemented method may further include: periodically monitoring, by the insurance billing computing system, a claim status of the at least one insurance claim; and detecting, by the insurance billing computing system, a change in the claim status of the at least one insurance claim. The computer-implemented method may further include: responsive to detecting the change in the claim status of the at least one insurance claim, transmitting, by the insurance billing computing system, an alert to one or both of the first patient computing device and the health care provider computing system. The computer-implemented method may further include: determining, by the insurance billing computing system, whether the patient resides in a state that has a telemedicine parity law. The computer-implemented method may further include: notifying the patient when it is determined that the patient does not reside in a state that has a telemedicine parity law. The computer-implemented method may further include: communicating, by the insurance billing computing system, in real-time with the insurance provider computing system to determine an eligibility status of at least one of the patient, the first health care provider, and the one or more health care services. The computer-implemented method may further include: communicating, by the insurance billing computing system, in real-time with an insurance provider intermediary computing system to determine an eligibility status of at least one of the patient, the first health care provider, and the one or more health care services. The computer-implemented method may further include: responsive to a determination that the first health care provider does not accept the one or more insurance plans of the first insurance provider, identifying, by the insurance billing computing system, at least a second health care provider that does accept the one or more insurance plans of the first insurance provider; and providing, by the insurance billing computing system, data that identifies the second health care provider to the first patient computing device. The computer-implemented method may further include: receiving, by the insurance billing computing system from the first patient computing device, patient input data that indicates a selection of the second health care provider by the patient; and responsive to receiving the user input data that indicates the selection of the second health care provider by the patient, enabling, by the insurance billing system, the telemedicine session to be conducted between the first patient device and a second health care provider computing system associated with the second health care provider rather than conducted via the first patient computing device and the health care provider computing system associated with the first health care provider. The computer-implemented method may further include: providing, by the health care provider computing system, a menu that includes a plurality of available billing codes for selection by the first health care provider during or subsequent to the telemedicine session. The computer-implemented method may further include: hosting or enabling, by the insurance billing computing system, the telemedicine session between the first patient computing device and the health care provider computing system.

A telemedicine system may be summarized as including: at least a first patient computing device; a health care provider computing system; and an insurance billing computing system that includes at least one processor and a non-transitory processor-readable medium that stores at least one of data or instructions that, when executed by the at least one processor, cause the insurance billing computing system to: receive information that identifies a patient that operates the first patient computing device, information that identifies a current geographical location of the patient computing device, information that identifies at least a first health care provider that operates the health care provider computing system, and information that identifies at least a first insurance provider that insures the patient; determine whether the first health care provider accepts one or more insurance plans of the first insurance provider based at least in part on the received information that identifies a patient that operates the first patient computing device, the information that identifies a current geographical location of the patient computing device, the information that identifies at least a first health care provider that operates the health care provider computing system, or the information that identifies at least a first insurance provider that insures the patient; receive one or more billing codes that respectively indicate one or more health care services performed by the first health care provider for the patient during a telemedicine session conducted via the first patient computing device and the health care provider computing system; generate at least one insurance claim based at least in part on the one or more billing codes that respectively indicate the one or more health care services performed by the first health care provider for the patient during the telemedicine session; and submit the at least one insurance claim to the first insurance provider via an insurance provider computing system.

The instructions or data, when executed by the at least one processor, may cause the insurance billing system to: receive information that verifies that the telemedicine session occurred between the patient and the first health care provider. The instructions or data, when executed by the at least one processor, may cause the insurance billing system to: determine whether the first health care provider accepts one or more insurance plans of the first insurance provider based at least in part on the received information that verifies that the telemedicine session occurred between the patient and the first health care provider. The instructions or data, when executed by the at least one processor, may cause the insurance billing system to: receive information which indicates an occurrence of a real-time communication between the patient computing device and the health care provider computing system. The instructions or data, when executed by the at least one processor, may cause the insurance billing system to: receive information that identifies at least one of a start time, end time or duration of the telemedicine session; and determine whether the first health care provider accepts one or more insurance plans of the first insurance provider based at least in part on the received information that identifies at least one of a start time, end time or duration of the telemedicine session. The instructions or data, when executed by the at least one processor, may cause the insurance billing system to: receive information relating to one or more of an Internet Protocol (IP) address, a media access control (MAC) address, an RFID identifier, a hardware embedded identifier, a software embedded identifier, Wi-Fi® location data, cell tower location data, a device fingerprint, or device GPS data. The instructions or data, when executed by the at least one processor, may cause the insurance billing system to: periodically monitor a claim status of the at least one insurance claim; and detect a change in the claim status of the at least one insurance claim. The instructions or data, when executed by the at least one processor, may cause the insurance billing system to: transmit an alert to one or both of the first patient computing device and the health care provider computing system responsive to a detection of the change in the claim status of the at least one insurance claim.

A telemedicine system may be summarized as including: at least a first patient computing device; a health care provider computing system; and an insurance billing computing system that includes at least one processor and a non-transitory processor-readable medium that stores at least one of data or instructions that, when executed by the at least one processor, cause the insurance billing computing system to: receive information that identifies a patient that operates the first patient computing device, information that identifies at least a first health care provider that operates the health care provider computing system, and information that identifies at least a first insurance provider that insures the patient; determine whether the first health care provider accepts one or more insurance plans of the first insurance provider; receive one or more billing codes that respectively indicate one or more health care services performed by the first health care provider for the patient during a telemedicine session conducted via the first patient computing device and the health care provider computing system; generate at least one insurance claim based at least in part on the one or more billing codes that respectively indicate the one or more health care services performed by the first health care provider for the patient during the telemedicine session; and submit the at least one insurance claim to the first insurance provider via an insurance provider computing system.

An insurance billing computing system may be summarized as including: at least one processor; and a non-transitory processor-readable medium that stores at least one of data or instructions that, when executed by the at least one processor, cause the insurance billing computing system to: receive information that identifies a patient that operates a first patient computing device, information that identifies at least a first health care provider that operates a health care provider computing system, and information that identifies at least a first insurance provider that insures the patient; determine whether the first health care provider accepts one or more insurance plans of the first insurance provider; receive one or more billing codes that respectively indicate one or more health care services performed by the first health care provider for the patient during a telemedicine session conducted via the first patient computing device and the health care provider computing system; generate at least one insurance claim based at least in part on the one or more billing codes that respectively indicate the one or more health care services performed by the first health care provider for the patient during the telemedicine session; and submit the at least one insurance claim to the first insurance provider via an insurance provider computing system.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1 is a block diagram of a telemedicine system that performs insurance billing, according to at least one illustrated implementation.

FIG. 2 is a flow chart diagram showing a method to perform insurance billing in a telemedicine system, according to at least one illustrated implementation.

FIGS. 3A and 3B are a flow chart diagram showing a method to perform insurance billing in a telemedicine system, according to at least one illustrated implementation.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures have not been shown or described in detail to avoid unnecessarily obscuring descriptions of the implementations.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the context clearly dictates otherwise. It should also be noted that the term “or” is generally employed in its broadest sense, that is, as meaning “and/or” unless the context clearly dictates otherwise.

The headings and Abstract of the Disclosure provided herein are for convenience only and do not interpret the scope or meaning of the implementations.

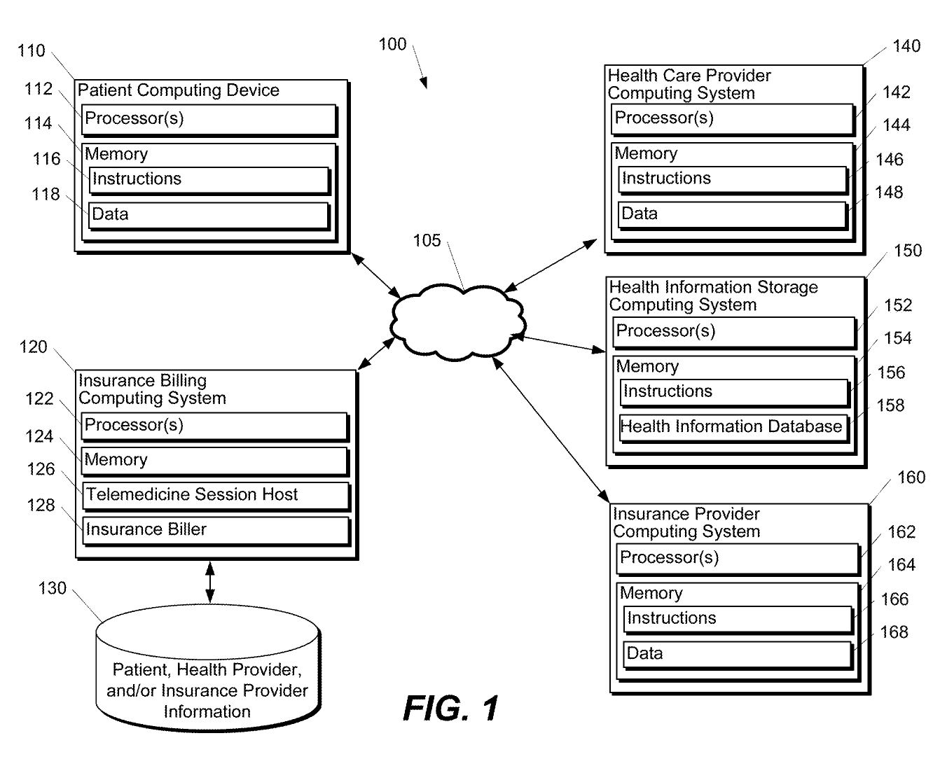

FIG. 1 is a block diagram of a telemedicine system 100 that performs insurance billing, according to at least one illustrated implementation. Generally, the system 100 is organized in a distributed fashion in which a patient computing device 110, an insurance billing computing system 120, a health care provider computing system 140, a health information storage computing system 150, and an insurance provider computing system 160 interact or otherwise communicate with each other via a communications network 105.

The system 100 can be used to enable telemedicine sessions between a patient that operates the patient computing device 110 and a health care provider that operates the health care provider computing system 140. For example, the insurance billing computing system 120 can enable or host the telemedicine session conducted between the patient computing device 110 and a health care provider that operates the health care provider computing system 140.

In addition, according to an aspect of the present disclosure, the insurance billing computing system 120 generates at least one insurance claim for health care services provided during the telemedicine session. The insurance billing computing system 120 submits the at least one insurance claim to the insurance provider computing system 160. Thus, the telemedicine system 100 performs insurance billing in addition to enabling telemedicine sessions between patients and health care providers.

Although only a single patient computing device 110 is illustrated in FIG. 1, the system 100 can include any number of patient computing devices via which different patients interact with any number of health care providers. Likewise, although only a single health care provider computing system 140 is illustrated in FIG. 1, the system 100 can include any number of different health care provider computing systems 140 via which different health care providers interact with any number of patients. Likewise, although only a single insurance provider computing system 160 is illustrated in FIG. 1, the system 100 can include any number of different insurance provider computing systems 160 via which different insurance providers can receive insurance claims for patients which they respectively insure.

The patient computing device 110 can be any type of computing device that can engage in a telemedicine session. For example, the patient computing device 110 can be a laptop computer, personal computer, desktop computer, tablet computing device, smartphone, personal digital assistant, gaming console, videoconferencing system, portable media player, or other type of computing device.

The patient computing device 110 includes a processor 112 and a memory 114. The processor 112 can be one processor or a plurality of processors that are operatively coupled. The processor 112 can be any processing device, such as a microprocessor, microcontroller, integrated circuit, circuitry that implements computer logic, or some combination thereof. The memory 114 can include any non-transitory information storage device, including, but not limited to, RAM, ROM, hard drives, flash drives, optical media, other memory devices, or some combination thereof. The memory 114 can store information accessible by processor 112, including instructions 116 that can be executed by processor 112. The instructions 116 can be any set of instructions that when executed by the processor 112, cause the processor 112 to provide desired functionality. The memory 114 can also store data 118.

In some implementations, the memory 114 of the patient computing device 110 stores a downloadable application (i.e. “app”) that, when executed by the processor 112, controls communications between the patient computing device 110 and the insurance billing computing system 120, the health care provider computing system 140, the health information storage computing system 150, and/or the insurance provider computing system 160. For example, the application may be designed and provided by an entity that operates the insurance billing computing system 120.

The application may include instructions that cause the patient computing device 110 to engage in a telemedicine session or perform other operations such as receive and relay patient account information, insurance claim information, geo-location information, address information (e.g., internet protocol (IP) address of the patient computing device, mailing or billing address of patient), telemedicine session information (e.g., indication of occurrence, duration, images, video, audio), or other data between the patient computing device 110 and the insurance billing computing system 120. The application may provide information to and receive information from the patient using one or more user interfaces.

Preferably, the patient computing device 110 includes one or more input/output components (not shown) that enable the telemedicine session to be conducted. For example, the patient computing device 110 can include one or more of speakers, a microphone, a display, a keyboard, a mouse, a camera, or other such devices that enable teleconferencing and/or videoconferencing.

The patient computing device 110 may include the ability to determine its geographic location using one or more location-identifying techniques, such as global positioning system (GPS), near field communications (NFC), cell tower identification, Internet Protocol (IP) address, media access control (MAC) address, RFID identifier, hardware embedded identifier, software embedded identifier, Wi-Fi® location data, device fingerprint, etc. In such implementations, the patient computing device 110 may include a GPS transceiver, RFID reader, or other components which enable the patient computing device to determine its geographic location. The memory 114 may include a location-determining module which identifies the location of the patient computing device 110 and processes the location information into a form which may be passed to other components of the system 100, such as the insurance billing computing system 120.

The health care provider computing system 140, the health information storage computing system 150, and the insurance provider computing system 160 can each include a processor (142, 152, and 162, respectively) and a non-transitory memory (144, 154, and 164, respectively). Similar to processor 112 and memory 114, processors 142, 152, and 162 can respectively be any processing device or combination of such devices. Likewise, memory 144, memory 154, and memory 164 can respectively include any information storage device or combination of such devices. Each memory 144, 154, and 164 can store instructions (146, 156, and 166, respectively) and data (148, 158, and 168, respectively, with data 158 shown as a health information database 158).

The health care provider computing system 140 can include one or more computing devices that are operatively connected. For example, the health care provider computing system 140 can be a computing system located at a hospital, a physician's office, a pharmacy, a nursing facility, and/or other health care locations. Preferably, the health care provider computing system 140 includes one or more input/output components (not shown) that enable the telemedicine session to be conducted. For example, the health care provider computing system 140 can include one or more of speakers, a microphone, a display, a keyboard, a mouse, a camera, or other such devices that enable teleconferencing and/or videoconferencing.

The health information storage computing system 150 includes one or more computing devices that are operatively connected. For example, the health information storage computing system 150 can include one or more server computing devices that provide access to a health information database 158 over network 105. In some implementations, the health information storage computing system 150 may be denominated as a cloud-based health storage system. The health information storage computing system 150 can include multiple, separate storage systems. For example, in some implementations, the health information storage computing system 150 can include the Microsoft HealthVault™ system and/or other similar systems.

The health information database 158 can store health information associated with one or more patients. For example, the health information database 158 can store medication information, health history, prescription history, allergy information, fitness information, blood pressure information, lab results, information about current and past conditions and illnesses, medical records such as physician notes, x-rays, scans, or other images. Such information may be accessible by or provided to one or both of the patient (via the patient computing device 110) and the health care provider (via the health care provider computing system 140) before, during, and/or after a telemedicine session conducted between the patient and the health care provider over network 105.

In some implementations, one or more medical or fitness devices (e.g., blood pressure monitors, glucose monitors, pulse monitors, oxygen sensors, step counters, scales, sleep monitoring devices, etc.) may be connected to the patient computing device 110 or connected (e.g., wirelessly) to the system 100 generally. Data generated by the one or more medical or fitness devices may be stored in the health information database 158 and/or may be provided in real time during a telemedicine session.

The insurance provider computing system 160 can include one or more computing devices that are operatively connected. In some implementations, the insurance provider computing system 160 includes one or more server computing devices that provide information using an application programming interface. For example, in some implementations, the insurance provider computing system 160 includes one or more server computing devices that provide real-time eligibility checks, claim submission, real-time claim status checks, or other information stored in a database included in system 160 (e.g., via an application programming interface).

In some implementations, the system 100 includes an insurance provider intermediary computing system (not shown) connected to network 105. The insurance billing computing system 120 can cooperatively operate, instruct, or otherwise communicate with the insurance provider intermediary computing system to query or otherwise communicate with one or more insurance provider computing systems 160 on behalf of the insurance billing computing system 120.

The insurance billing computing system 120 includes one or more computing devices that are operatively connected. In some implementations, the insurance billing computing system 120 includes one or more server computing devices that are operatively connected. The server computing devices can be arranged according to any computer architecture, including parallel, sequential, and/or distributed computing architectures.

The server computing devices can interact with patient computing device 110, health care provider computing system 140, health information storage computing system 150, and/or insurance provider computing system 160 over network 105. For example, insurance billing computing system 120 can communicate with patient computing device 110 via an application stored and locally executed at the patient computing device 110. As another example, the insurance billing computing system 120 can communicate with health care provider computing system 140 using a web application. For example, health care provider computing system 140 can use a browser application to interact with or execute portions of the web application. Other structures or distributions of processing may be used as well.

The insurance billing computing system 120 includes a processor 122 and a memory 124. The processor 122 can be one processor or a plurality of processors that are operatively coupled. The processor 122 can be any processing device, such as a microprocessor, microcontroller, integrated circuit, other device that implements computer logic, or some combination thereof. The memory 124 can include any non-transitory information storage device, including, but not limited to, RAM, ROM, hard drives, flash drives, optical media, other memory devices, or some combination thereof. The memory 124 can store information accessible by processor 122, including instructions that can be executed by processor 122. The instructions can be any set of instructions that when executed by the processor 122, cause the processor 122 to provide desired functionality. The memory 124 can also store data.

The insurance billing computing system 120 includes a telemedicine session host 126, an insurance biller 128, and a database 130 that stores patient, health provider, and/or insurance provider information (e.g., user account information, heath care provider rosters, insurance plans accepted by each health care provider, insurance provider-specific claim formats, etc.).

The insurance billing computing system 120 implements the telemedicine session host 126 to host or otherwise enable telemedicine sessions between the patient computing device 110 and the health care provider computing system 140. For example, insurance billing computing system 120 can implement telemedicine session host 126 to provide video or audio conferencing functionality.

In some implementations, the patient computing device 110 and the health care provider computing system 140 communicate directly and do not use a session host. In some implementations, insurance billing computing system 120 does not include telemedicine session host 126. For example, insurance billing computing system may be used in a non-telemedicine context or a separate system may perform telemedicine session hosting.

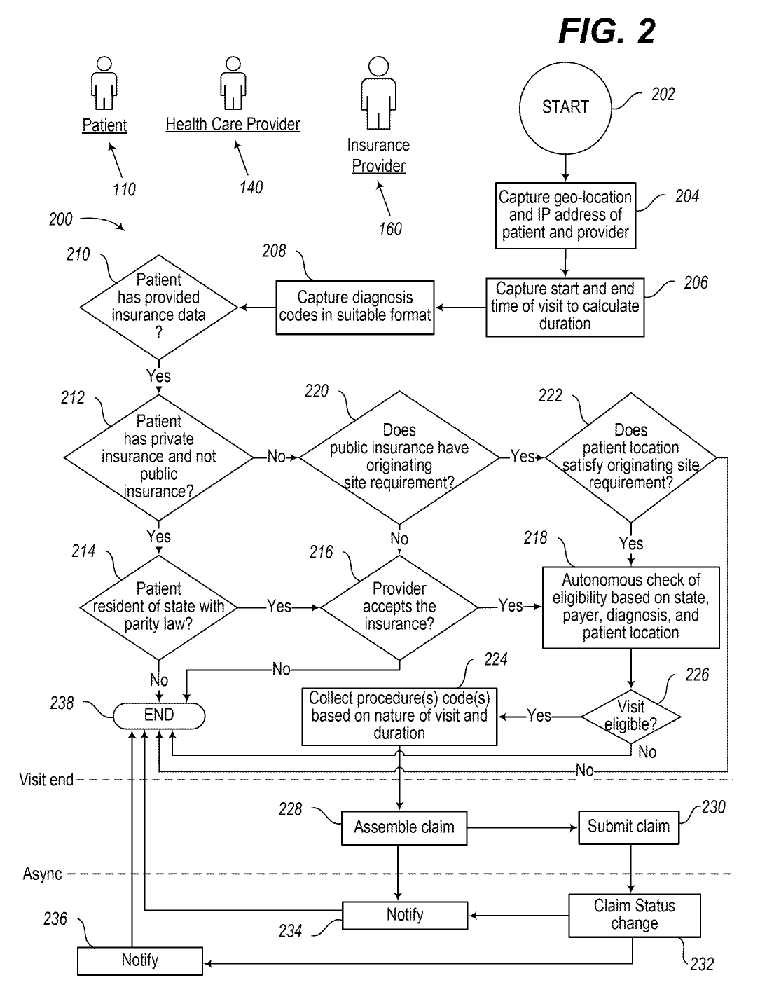

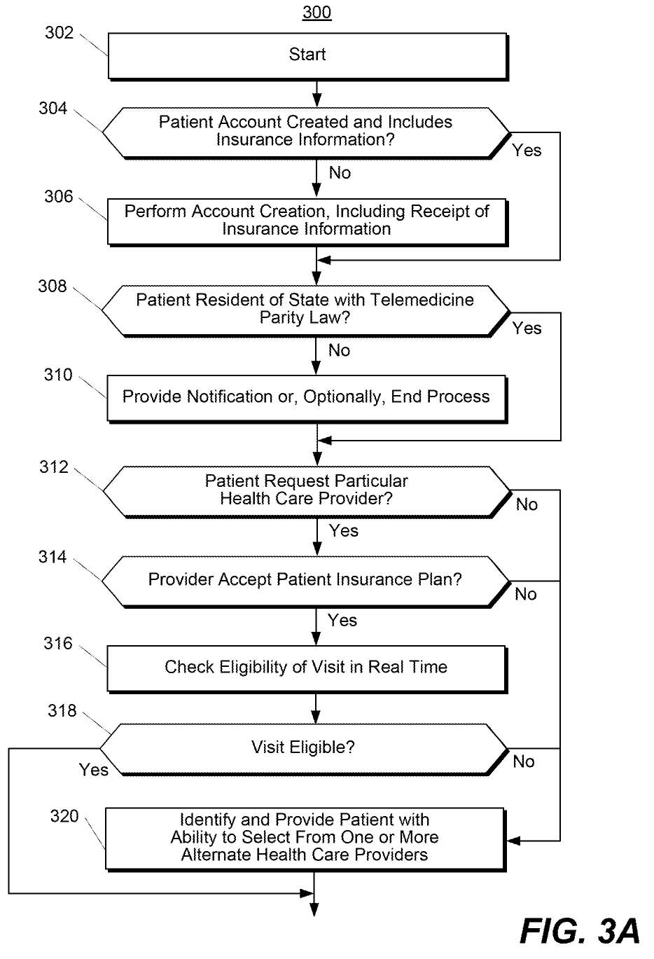

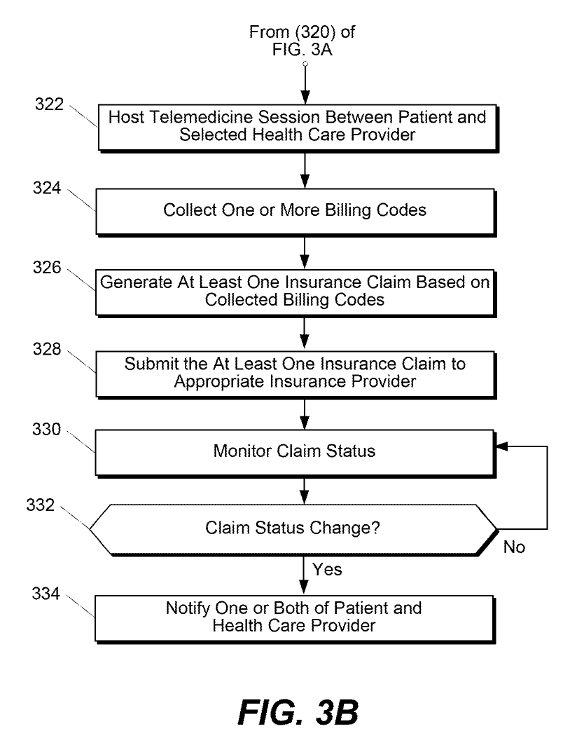

The insurance billing computing system 120 implements the insurance biller 128 to perform insurance billing. For example, insurance billing computing system 120 can implement insurance biller 128 to perform aspects of methods 200 and 300 of FIG. 2 and FIGS. 3A and 3B, respectively. In some implementations, the insurance biller 128 interacts with the other computing systems 110, 140, 150, and 160 using vendor-approved or vendor-supplied application programming interfaces.

In some implementations, the insurance billing computing system 120 implements the insurance biller 128 in an automated or autonomous fashion. For example, billing may be performed periodically not responsive to human prompting or may be performed autonomously. Alternatively, the insurance billing computing system 120 implements the insurance biller 128 responsive to human prompting or according to a defined schedule. In some implementations, the insurance billing computing system 120 implements the insurance biller 128 according to one or more user-defined conditions that specify certain rules, logic, and/or times according to which insurance billing should (or should not) be performed. In some implementations, insurance biller 128 is implemented to perform insurance billing in the context of a traditional, face-to-face patient/health care provider visit and is, therefore, not limited to the telemedicine context.

In some implementations, the insurance biller 128 includes processor-executable instructions stored in or loaded into memory 124 and executed by processor 122. In other implementations, the insurance biller 128 includes one or more circuits (e.g., integrated circuits), logic components, or other items of computer hardware configured to implement computer logic or perform other functionality. In other implementations, the insurance biller 128 can be implemented using some combination of processor-executable instructions and circuitry.

Network 105 can be any type of communications network, such as a local area network (e.g., intranet), wide area network (e.g., Internet), or some combination thereof and can include any number of wired or wireless links. In general, communication between the components of system 100 via network 105 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

Due to the inherent flexibility of computer-based systems, a great variety of possible configurations, combinations, and divisions of tasks and functionality between and among the components of the system 100 are possible. For instance, tasks shown as being performed at a certain device can instead be performed at other devices. Any combination of general-purpose and special-purpose computing devices can be used.

FIG. 2 is a flow chart diagram showing a method 200 to perform insurance billing in a telemedicine system, according to at least one illustrated implementation. In particular, the flow chart diagram of FIG. 2 is organized to show certain portions of the method 200 that are performed by or in association with various components of the telemedicine system 100 of FIG. 1.

The method 200 begins at 202. At 204, the insurance billing computing system 120 may capture the current geographic location of the patient computing device 110 and/or the health care provider computing system 140. The insurance billing computing system 120 may also capture other information (e.g., IP address) of the patient computing device 110 and/or the health care provider computing system 140, which information may be used to determine the current location of the patient computing device and/or the health care provider computing system 140. The patient computing device 110 and the health care provider computing system 140 may each determine their respective geographic location. As discussed above, the patient computing device 110 and/or the health care provider computing system 140 may use one or more techniques (e.g., GPS) which include one or more of a variety of types of wireless transmission of electromagnetic signals and/or user input of information. Such geo-location and IP address information may be used by the insurance billing computing system 120 for insurance billing purposes (e.g., eligibility determinations) as well as for fraud prevention. As a non-limiting example, the captured location information may be compared to expected patient location information (e.g., billing address, mailing address), which may be used to detect fraud by detecting a mismatch between the two locations.

At 206, the insurance billing computing system 120 may capture a start time and an end time for the telemedicine session between the patient computing device 110 and the health care provider computing system 140. As a more general example, the insurance billing computing system 120 may capture information which indicates that a real-time communication between the patient computing device 110 and the health care provider computing system 140 occurred. Such information may be used to determine the duration of the telemedicine session, which may be important for insurance billing purposes as well as for fraud detection or prevention purposes.

At 208, the insurance billing computing system 120 may capture diagnostic codes for the telemedicine session. Such diagnostic codes may be in any suitable format (e.g., ICD 10 format), and may be used to determine whether or to what extent the telemedicine session is covered by the patient's insurance provider.

At 210, the patient provides his or her insurance data to the system 100. For example, the insurance billing computing system 120 and the patient computing device 110 may cooperatively operate to present one or more user interfaces to the patient on a display of the patient computing device 110. The user interfaces allow the patient to enter health care information, such as insurance information (e.g., insurance provider identity, policy number, plan name, group name, primary policy holder, etc.). If the patient does not provide at least information that identifies an insurance provider that insures the patient, the method may optionally end at 238.

If the patient has provided insurance data, then at 212 the system 100 determines if the patient has private insurance and not public insurance (e.g., Medicare, Medicaid). For example, the insurance billing computing system 120 may determine what type of insurance the patient has based at least in part on the insurance data provided by the patient at 210.

If the patient has private insurance, then at 214 the system 100 decides if the patient is a resident of a state with parity law. For example, insurance billing computing system 120 may compare any address information provided by the patient via patient computing device 110 to data that identifies states in which telemedicine parity laws exist (i.e. are in legal force). The insurance billing computing system 120 may additionally or alternatively utilize location information and/or IP address information received from the patient computing device 110 to determine the state in which the patient resides or is currently present. If the patient is not a resident of state with parity law, the method may optionally end at 238.

However, if the patient is a resident of a state with parity law, then at 216 the system 100 checks if the health care provider accepts the insurance that the patient has. For example, the insurance billing computing system 120 may optionally communicate with the health care provider computing system 140 to receive confirmation from the health care provider computing system 140 that the health care provider accepts the patient's insurance. Alternatively, such information may be retrieved from database 130. In such instances, the insurance billing computing system 120 may make a preliminary determination regarding whether the health care provider accepts the patient's insurance without receiving a real-time confirmation from the health care provider computing system 140. If the provider does not accept the patient's insurance, the method may optionally end at 238.

However, if the provider does accept the patient's insurance, then at 218 the system 100 autonomously checks to determine if the patient's telemedicine session with the health care provider is eligible based at least in part on the patient's state, the payer, the diagnosis, and/or the patient's current physical location. For example, the insurance billing computing system 120 may optionally communicate with the insurance provider computing system 160 to receive confirmation from the insurance provider computing system 160 that the proposed telemedicine session between the patient and health care provider is eligible for reimbursement. The results of such checking may be provided in real-time. Alternatively, such information may be retrieved from database 130 without real-time confirmation from the insurance provider computing system 160. If the system 100 determines at 226 that the visit is ineligible for insurance, the method may optionally end at 238.

However, if the system 100 determines at 226 that the visit is eligible, then at 224 the system 100 collects procedure codes based on the nature of the telemedicine session and the determined duration of the session. For example, the insurance billing computing system 120 and the health care provider computing system 140 may cooperatively operate to present one or more user interfaces to the health care provider on a display of the health care provider computing system 140. The user interfaces allow the health care provider to enter (e.g., select from a “drop-down” menu) the one or more billing codes.

Returning to act 212, if the patient has public insurance, then at 220 the system 100 determines whether the public insurance has an originating site requirement. An originating site requirement is a requirement that the patient be in a designated location (e.g., rural Health Professional Shortage Area (HPSA)) at the time the telemedicine session occurs. If the system 100 determines that the public insurance does not have an originating site requirement, then at 216 the system 100 checks if the health care provider accepts the insurance that the patient has, as discussed above. However, if the system 100 determines that the public insurance does have an originating site requirement, then at 222 the system checks whether the patient's current location, captured at 204, satisfies the originating site requirement. If the patient's location satisfies the originating site requirement, then at 218 the system 100 autonomously checks to determine if the patient's telemedicine session with the health care provider is eligible based at least in part on the patient's state, the payer, the diagnosis, and/or the patient's current physical location, as discussed above. If the patient's location does not satisfy the originating site requirement, the method may optionally end at 238.

Upon completing the patient's telemedicine session with the health care provider, at 228 the system 100 assembles an insurance claim using the codes (e.g., diagnostic codes) collected from one or more entities, such as the health care provider. For example, the insurance billing computing system 120 may consult database 130 to retrieve insurance provider-specific claim formats or structures when assembling the claim.

At 230, the system 100 submits the assembled claim to the insurance provider. For example, the insurance billing computing system 120 may cooperatively operate with the insurance provider computing system 160 to submit the assembled claim to a database included in the insurance provider computing system 160.

When the system 100 detects a change in the claim status at 232, then at 234 and 236 the system 100 notifies one or both of the patient and the health care provider, completing the method 200. For example, the insurance billing computing system 120 and the health care provider computing system 140 may cooperatively operate to present one or more user interfaces to the health care provider on a display of the health care provider computing system 140. The user interface can provide notification of the change in the claim status. Likewise, a similar user interface can be provided to the patient via a display of the patient computing device 110.

FIGS. 3A and 3B are a flow chart diagram showing a method 300 to perform insurance billing in a telemedicine system, according to at least one illustrated implementation. Referring first to FIG. 3A, the method 300 begins at 302.

At 304, the insurance billing computing system 120 determines whether a patient account has been created for a patient and includes insurance information. If the insurance billing computing system 120 determines at 304 that a patient account has been created for the patient and includes insurance information, the method 300 proceeds to 308.

However, if the insurance billing computing system 120 determines at 304 that a patient account has not been created or does not include insurance information, then method 300 proceeds to 306.

At 306, the insurance billing computing system 120 performs account creation including requesting and receiving insurance information from the patient. For example, the insurance billing computing system 120 can cooperatively operate with the patient computing device 110 to obtain information from the patient to generate the patient account. As examples, information used to create or otherwise included in the patient account can include insurance information such as the identity of the patient's health care insurance provider, a policy number, a plan name, a group number, information concerning dependents or dependence, identification of a primary policy holder or other insurance information. As further examples, information used to create or otherwise included in the patient account can include a patient date of birth, a patient address, a preferred pharmacy, health information manually entered by the patient, log in information (e.g., username and/or password) for one or more health information storage accounts respectively provided by one or more health information storage computing systems 150, or other information pertinent to telemedicine and insurance billing services.

At 308, the insurance billing computing system 120 determines whether the patient is a resident of a state with a telemedicine parity law. For example, the insurance billing computing system 120 can compare the patient's address stored in the patient account with a list (e.g., stored in database 130) that identifies which states have telemedicine parity laws and which states do not have telemedicine parity laws. Alternatively, the insurance billing computing system 120 can cooperatively operate with the patient computing device 110 to request and receive user input from the patient that identifies the patient's state of residence. As discussed above, in some implementations the patient's current location may be captured autonomously from the patient computing device 110 via a suitable technique (e.g., GPS, IP address, cell tower identification).

If the insurance billing computing system 120 determines at 308 that the patient is a resident of a state with a telemedicine parity law, then method 300 proceeds to 312. However, if the insurance billing computing system 120 determines at 308 that the patient is not a resident of a state with a telemedicine parity law, then method 300 proceeds to 310.

At 310, the insurance billing computing system 120 provides a notification to the patient computing device 110 for display to the patient. The notification may notify the patient that he or she is a resident of a state that does not have a telemedicine parity law and may optionally provide further explanation regarding patient rights and/or insurance reimbursement policies. Optionally, the process may end at 310.

At 312, the insurance billing computing system 120 determines whether the patient has requested a particular health care provider. For example, the patient may have a preferred provider or may have previously selected one from a menu. If the patient has not requested a particular health care provider, then method 300 proceeds to 320. However, if the insurance billing computing system 120 determines that the patient has requested a particular health care provider, then method 300 proceeds to 314.

At 314, the insurance billing computing system 120 determines whether the requested health care provider accepts the patient's insurance plan. For example, the insurance billing computing system 120 can consult information stored in database 130 that indicates, for each of one or more health care providers that participate in the telemedicine system 100, which insurance policies, plans, and/or providers are accepted by each of such health care providers. Alternatively, the insurance billing computing system 120 may query or otherwise communicate with one or both of the health care provider computing system 140 that is operated by the requested health care provider and the insurance provider computing system 160 that is operated by the insurance provider that insures the patient. For example, such queries may use an application programming interface to query a dynamic database that stores information describing which insurance policies are accepted by the requested health care provider. The database may be maintained at the health care provider computing system 140 and/or the insurance provider computing system 160.

If the insurance billing computing system 120 determines at 314 that the requested health care provider does not accept the patient's insurance plan, then method 300 proceeds to 320. However, if the insurance billing computing system 120 determines at 314 that the requested health care provider does accept the patient's insurance plan, then method 300 proceeds to 316.

At 316, the insurance billing computing system 120 checks an eligibility status of one or more of the patient, the requested health care provider, and one or more health care services to be performed by the requested health care provider in the telemedicine session. As discussed above, such eligibility status may be determined based in part on the patient's current location, the duration of the telemedicine session, etc. In some implementations, at 316, the insurance billing computing system 120 can communicate in real-time with the insurance provider computing system 160 that is operated by the patient's insurance provider to check the eligibility status of one or more of the patient, the requested health care provider, and the one or more health care services. In other implementations, at 316, the insurance billing computing system 120 can communicate in real-time with an insurance provider intermediary computing system to check the eligibility status. For example, the insurance billing computing system 120 (or the insurance provider intermediary computing system on behalf of the insurance billing computing system 120) can use an application programming interface to query a dynamic database that stores information regarding eligibility status of one or more of the patient, the requested health care provider, and the one or more health care services. The database may be maintained at the insurance provider computing system 160.

At 318, the insurance billing computing system 120 determines whether the telemedicine session is eligible for insurance reimbursement. In particular, the insurance billing computing system 120 may consider the eligibility status retrieved at 316 to determine whether the visit is eligible. If the insurance billing computing system 120 determines that the visit is eligible, then method 300 proceeds to 322 of FIG. 3B. However, if the insurance billing computing system 120 determines that the visit is not eligible, then method 300 proceeds to 320.

At 320, insurance billing computing system 120 identifies and provides the patient with the ability to select from one or more alternate health care providers. For example, operations similar to those described at blocks 314 through 318 may be performed with respect to one or more candidate health care providers. The insurance billing computing system 120 can identify alternate health care providers with whom the patient may conduct a telemedicine session eligible for insurance reimbursement. The insurance billing computing system 120 can cooperatively operate with one or both of the patient computing device 110 and one or more health care provider computing systems 140 that are respectively operated by the alternate health care providers to schedule and enable a telemedicine session between the patient and a patient-selected one of the alternate health care providers. After 320, method 300 proceeds to 322 of FIG. 3B.

Referring now to FIG. 3B, at 322, the insurance billing computing system 120 hosts or otherwise enables the telemedicine session between the patient and the selected health care provider. For example, the telemedicine session host 126 may enable a videoconference or other telemedicine session between the patient computing device 110 and the health care provider computing system 140 operated by the selected health care provider over network 105. As discussed above, the insurance billing computing system 120 may capture the location of the patient computing device 110 during the telemedicine session as well as the start time, stop time and duration of the telemedicine session.

However, in other implementations, the insurance billing computing system 120 does not host or otherwise enable the telemedicine session in any way. For example, a wholly different computing system from system 120 may host or enable the telemedicine session. Further, as noted above, insurance billing computing system 120 can perform insurance billing in a traditional, face-to-face patient/health care provider visit and is not limited to the telemedicine context.

During the telemedicine session, the patient and/or the health care provider may be provided with access to information such as, for example, patient health information stored in health information database 158, patient health information stored in database 130, and/or patient health information provided in real-time by one or more medical or fitness devices connected to the patient computing device 110 or connected wirelessly via network 105 (e.g., blood pressure monitors, glucose monitors, pulse monitors, oxygen sensors, step counters, scales, sleep monitoring devices, etc.).

At 324, the telemedicine billing computing system 120 collects one or more billing or diagnostic codes. For example, the telemedicine billing computing system 120 and the health care provider computing system 140 may cooperatively operate to provide the health care provider with a menu of billing codes from which to select. The health care provider can select those billing codes that correspond to particular health care services provided by the health care provider to the patient during the telemedicine session. In some implementations, the menu of billing codes may be tailored or otherwise uniquely edited based on one or more of the identity of the health care provider and the identity of the insurance provider that insures the patient.

At 326, the insurance billing computing system 120 generates at least one insurance claim based on the billing codes collected at 324. For example, the insurance billing computing system 120 can insert the collected billing codes into a particular format, document type, command string, or other data structure that represents an electronically-submittable insurance claim. In some implementations, the format, structure, or contents of the insurance claim may be dependent upon the identity of the insurance provider that insures the patient. Therefore, in such implementations, when generating the insurance claim at 326 the insurance billing computing system 120 may consult information stored in database 130 that describes insurance claim formats, structures, etc. respectively associated with different insurance providers.

At 328, the insurance billing computing system 120 submits the at least one insurance claim generated at 326 to the appropriate insurance provider. In some implementations, insurance billing computing system 120 uses an application programming interface to directly submit the at least one insurance claim to the insurance provider computing system 160. In other implementations the insurance billing computing system 120 interacts or otherwise communicates with an insurance provider intermediary computing system to submit the at least one insurance claim to the insurance provider computing system 160 on behalf of the insurance billing computing system 120. The insurance provider intermediary computing system may use the application programming interface to submit the at least one insurance claim.

At 330, the insurance billing computing system 120 monitors a status of the submitted insurance claim. For example, the insurance billing computing system 120 can use an application programming interface to periodically query a dynamic database that stores information regarding the status of pending insurance claims. The database may be maintained at the insurance provider computing system 160 operated by the insurance provider to whom the claim was submitted.

At 332, the insurance billing computing system 120 determines whether the status of the claim has changed, for example, based on the results of the monitoring performed at 330. If the insurance billing computing system 120 determines at 332 that the status of the claim has not changed, then method 300 returns to 330 and the insurance billing computing system 120 continues to monitor the claims status. However, if the insurance billing computing system 120 determines at 332 that the status of the claim has changed, then method 300 proceeds to 334.

At 334, the insurance billing computing system 120 notifies one or both of the patient and the health care provider regarding the change in the status of the claim. For example, the insurance billing computing system 120 may send notifications or alerts to one or both of the patient computing device 110 and the health care provider computing system 140. The patient computing device 110 and the health care provider computing system 104 can display or otherwise indicate the contents of the notifications or alerts to the patient and the health care provider, respectively.

Those of skill in the art will recognize that many of the methods or algorithms set out herein may employ additional acts, may omit some acts, and/or may execute acts in a different order than specified.

The various implementations described above can be combined to provide further implementations. U.S. Provisional Patent Application Ser. No. 62/140,379, filed Mar. 30, 2015, is incorporated herein by reference, in its entirety. Aspects of the implementations can be modified, if necessary, to employ systems, circuits and concepts of the various patents, applications and publications to provide yet further implementations.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A computer-implemented method in a telemedicine system that includes at least a first patient computing device, a health care provider computing system, and an insurance billing computing system that includes at least one processor, the method comprising:
receiving, by the insurance billing computing system, information that identifies a patient that operates the first patient computing device, information that identifies a current geographical location of the patient computing device, information that identifies at least a first health care provider that operates the health care provider computing system, and information that identifies at least a first insurance provider that insures the patient;
determining, by the insurance billing computing system, whether the first health care provider accepts one or more insurance plans of the first insurance provider based at least in part on the received information that identifies a patient that operates the first patient computing device, the information that identifies a current geographical location of the patient computing device, the information that identifies at least a first health care provider that operates the health care provider computing system, or the information that identifies at least a first insurance provider that insures the patient;
receiving, by the insurance billing computing system, one or more billing codes that respectively indicate one or more health care services performed by the first health care provider for the patient during a telemedicine session conducted via the first patient computing device and the health care provider computing system;
generating, by the insurance billing computing system, at least one insurance claim based at least in part on the one or more billing codes that respectively indicate the one or more health care services performed by the first health care provider for the patient during the telemedicine session; and
submitting, by the insurance billing computing system, the at least one insurance claim to the first insurance provider via an insurance provider computing system.

2. The computer-implemented method of claim 1, further comprising:
receiving, by the insurance billing computing system, information that verifies that the telemedicine session occurred between the patient and the first health care provider.

3. The computer-implemented method of claim 2, further comprising:
determining, by the insurance billing computing system, whether the first health care provider accepts one or more insurance plans of the first insurance provider based at least in part on the received information that verifies that the telemedicine session occurred between the patient and the first health care provider.

4. The computer-implemented method of claim 2 wherein receiving information that verifies that the telemedicine session occurred between the patient and the first health care provider comprises receiving information which indicates an occurrence of a real-time communication between the patient computing device and the health care provider computing system.

5. The computer-implemented method of claim 1, further comprising:
receiving, by the insurance billing computing system, information that identifies at least one of a start time, end time or duration of the telemedicine session; and
determining, by the insurance billing computing system, whether the first health care provider accepts one or more insurance plans of the first insurance provider based at least in part on the received information that identifies at least one of a start time, end time or duration of the telemedicine session.

6. The computer-implemented method of claim 1 wherein receiving information that identifies a current geographical location of the patient computing device comprises receiving information relating to one or more of an Internet Protocol (IP) address, a media access control (MAC) address, an RFID identifier, a hardware embedded identifier, a software embedded identifier, Wi-Fi® location data, cell tower location data, a device fingerprint, or device GPS data.

7. The computer-implemented method of claim 1, further comprising:
periodically monitoring, by the insurance billing computing system, a claim status of the at least one insurance claim; and
detecting, by the insurance billing computing system, a change in the claim status of the at least one insurance claim.

8. The computer-implemented method of claim 7, further comprising:
responsive to detecting the change in the claim status of the at least one insurance claim, transmitting, by the insurance billing computing system, an alert to one or both of the first patient computing device and the health care provider computing system.

9. The computer-implemented method of claim 1, further comprising:
determining, by the insurance billing computing system, whether the patient resides in a state that has a telemedicine parity law.

10. The computer-implemented method of claim 1, further comprising:
notifying the patient when it is determined that the patient does not reside in a state that has a telemedicine parity law.

11. The computer-implemented method of claim 1, further comprising:
communicating, by the insurance billing computing system, in real-time with the insurance provider computing system to determine an eligibility status of at least one of the patient, the first health care provider, and the one or more health care services.

12. The computer-implemented method of claim 1, further comprising:
communicating, by the insurance billing computing system, in real-time with an insurance provider intermediary computing system to determine an eligibility status of at least one of the patient, the first health care provider, and the one or more health care services.

13. The computer-implemented method of claim 1, further comprising:
responsive to a determination that the first health care provider does not accept the one or more insurance plans of the first insurance provider, identifying, by the insurance billing computing system, at least a second health care provider that does accept the one or more insurance plans of the first insurance provider; and
providing, by the insurance billing computing system, data that identifies the second health care provider to the first patient computing device.

14. The computer-implemented method of claim 13, further comprising:
receiving, by the insurance billing computing system from the first patient computing device, patient input data that indicates a selection of the second health care provider by the patient; and
responsive to receiving the user input data that indicates the selection of the second health care provider by the patient, enabling, by the insurance billing system, the telemedicine session to be conducted between the first patient device and a second health care provider computing system associated with the second health care provider rather than conducted via the first patient computing device and the health care provider computing system associated with the first health care provider.

15. The computer-implemented method of claim 1, further comprising:
providing, by the health care provider computing system, a menu that includes a plurality of available billing codes for selection by the first health care provider during or subsequent to the telemedicine session.

16. The computer-implemented method of claim 1, further comprising:
hosting or enabling, by the insurance billing computing system, the telemedicine session between the first patient computing device and the health care provider computing system.

17. A telemedicine system, comprising:
at least a first patient computing device;
a health care provider computing system; and
an insurance billing computing system that includes at least one processor and a non-transitory processor-readable medium that stores at least one of data or instructions that, when executed by the at least one processor, cause the insurance billing computing system to:
receive information that identifies a patient that operates the first patient computing device, information that identifies a current geographical location of the patient computing device, information that identifies at least a first health care provider that operates the health care provider computing system, and information that identifies at least a first insurance provider that insures the patient;
determine whether the first health care provider accepts one or more insurance plans of the first insurance provider based at least in part on the received information that identifies a patient that operates the first patient computing device, the information that identifies a current geographical location of the patient computing device, the information that identifies at least a first health care provider that operates the health care provider computing system, or the information that identifies at least a first insurance provider that insures the patient;
receive one or more billing codes that respectively indicate one or more health care services performed by the first health care provider for the patient during a telemedicine session conducted via the first patient computing device and the health care provider computing system;
generate at least one insurance claim based at least in part on the one or more billing codes that respectively indicate the one or more health care services performed by the first health care provider for the patient during the telemedicine session; and
submit the at least one insurance claim to the first insurance provider via an insurance provider computing system.

18. The telemedicine system of claim 17 wherein the instructions or data, when executed by the at least one processor, cause the insurance billing system to:
receive information that verifies that the telemedicine session occurred between the patient and the first health care provider.

19. The telemedicine system of claim 18 wherein the instructions or data, when executed by the at least one processor, cause the insurance billing system to:
determine whether the first health care provider accepts one or more insurance plans of the first insurance provider based at least in part on the received information that verifies that the telemedicine session occurred between the patient and the first health care provider.

20. The telemedicine system of claim 18 wherein the instructions or data, when executed by the at least one processor, cause the insurance billing system to:
receive information which indicates an occurrence of a real-time communication between the patient computing device and the health care provider computing system.

21. The telemedicine system of claim 17 wherein the instructions or data, when executed by the at least one processor, cause the insurance billing system to:
receive information that identifies at least one of a start time, end time or duration of the telemedicine session; and
determine whether the first health care provider accepts one or more insurance plans of the first insurance provider based at least in part on the received information that identifies at least one of a start time, end time or duration of the telemedicine session.

22. The telemedicine system of claim 17 wherein the instructions or data, when executed by the at least one processor, cause the insurance billing system to:
receive information relating to one or more of an Internet Protocol (IP) address, a media access control (MAC) address, an RFID identifier, a hardware embedded identifier, a software embedded identifier, Wi-Fi® location data, cell tower location data, a device fingerprint, or device GPS data.

23. The telemedicine system of claim 17 wherein the instructions or data, when executed by the at least one processor, cause the insurance billing system to:
periodically monitor a claim status of the at least one insurance claim; and
detect a change in the claim status of the at least one insurance claim.

24. The telemedicine system of claim 17 wherein the instructions or data, when executed by the at least one processor, cause the insurance billing system to:
transmit an alert to one or both of the first patient computing device and the health care provider computing system responsive to a detection of the change in the claim status of the at least one insurance claim.

25. A telemedicine system, comprising:
at least a first patient computing device;
a health care provider computing system; and
an insurance billing computing system that includes at least one processor and a non-transitory processor-readable medium that stores at least one of data or instructions that, when executed by the at least one processor, cause the insurance billing computing system to:
receive information that identifies a patient that operates the first patient computing device, information that identifies at least a first health care provider that operates the health care provider computing system, and information that identifies at least a first insurance provider that insures the patient;
determine whether the first health care provider accepts one or more insurance plans of the first insurance provider;
receive one or more billing codes that respectively indicate one or more health care services performed by the first health care provider for the patient during a telemedicine session conducted via the first patient computing device and the health care provider computing system;
generate at least one insurance claim based at least in part on the one or more billing codes that respectively indicate the one or more health care services performed by the first health care provider for the patient during the telemedicine session; and
submit the at least one insurance claim to the first insurance provider via an insurance provider computing system.

26. An insurance billing computing system, comprising:
at least one processor; and
a non-transitory processor-readable medium that stores at least one of data or instructions that, when executed by the at least one processor, cause the insurance billing computing system to:
receive information that identifies a patient that operates a first patient computing device, information that identifies at least a first health care provider that operates a health care provider computing system, and information that identifies at least a first insurance provider that insures the patient;
determine whether the first health care provider accepts one or more insurance plans of the first insurance provider;
receive one or more billing codes that respectively indicate one or more health care services performed by the first health care provider for the patient during a telemedicine session conducted via the first patient computing device and the health care provider computing system;
generate at least one insurance claim based at least in part on the one or more billing codes that respectively indicate the one or more health care services performed by the first health care provider for the patient during the telemedicine session; and
submit the at least one insurance claim to the first insurance provider via an insurance provider computing system.
